(19) United States
(12) Patent Application Publication
(10) Pub. No.: US 2008/0187705 A1
(43) Pub. Date: Aug. 7, 2008

(54) METHOD OF NON-ABRASIVE MECHANICAL RELIEF OF A CELLULOSE SHEET AND APPARATUS

(76) Inventors: MARK SHAPTON, Three Rivers, MI (US); Paul Lautrup, Kalamazoo, MI (US)

Correspondence Address: MALDJIAN & FALLON LLC, 365 BROAD ST. , 3RD FLOOR, RED BANK, NJ, 07701, US

(21) Appl. No.: 12/025,065

(22) Filed: Feb. 4, 2008

Related U.S. Application Data
(60) Provisional application No. 60/888,008, filed on Feb. 2, 2007.
(60) Provisional application No. 60/890,200, filed on Feb. 16, 2007.

(51) Int. Cl. B32B 3/28; B29C 51/08; B31F 1/00; B32B 23/00

(52) U.S. Cl. 428/80; 428/156; 428/167; 428/165; 264/153; 264/129

(57) ABSTRACT

Embodiments of the present invention generally relate a method and apparatus of non-abrasive mechanical relief of a cellulose sheet to allow for uniform radius bending. In one embodiment of the present invention, a mechanically relieved sheet comprises a sheet comprising a cellulosic material and having a first surface, and at least a notched section on the first surface of the sheet comprising a plurality of indentations, wherein the first surface of the sheet is substantially free of visible cracks, wrinkles and abrasions.

### CROSS-REFERENCE TO RELATED APPLICATIONS

This application claims the benefit of U.S. Provisional Patent Application Ser. No. 60/888,008, filed Feb. 2, 2007, entitled “Method of Non-Abrasive Mechanical Relief of a Cellulose Sheet and Apparatus,” the disclosure of which is incorporated herein by reference in its entirety. This application also claims the benefit of U.S. Provisional Patent Application Ser. No. 60/890,200, filed Feb. 16, 2007, entitled “Method of Non-Abrasive Mechanical Relief of a Cellulose Sheet and Apparatus,” the disclosure of which is also incorporated herein by reference in its entirety.

### BACKGROUND

1. Field of the Invention

Embodiments of the present invention are generally related to a method and apparatus of non-abrasive mechanical relief of a cellulose sheet. More specifically, embodiments of the present invention generally relate a method and apparatus of non-abrasive mechanical relief of a cellulose sheet to allow for substantially uniform radius bending.

2. Description of the Related Art

Cellulose sheeting is used in a wide array of industries. In one application, cellulose sheeting is utilized as an underlayment for the flooring or roofs of vehicles, including recreational vehicles. In such applications, the cellulose sheeting generally encompasses the passenger compartment of the vehicle beneath the interior finishing. This generally requires the cellulose sheeting be pliable and able to conform to the shape and contour of the vehicle.

Often, the cellulose sheeting is merely bent or wrapped around bends and curves of the vehicle. In an attempt to facilitate easier bending of the cellulose sheeting during application, attempts have been made to mechanically relieve the cellulose sheeting by abrading the outer surface. One major problem with these known methods is the remaining fibrous debris on the sheet caused by the abrasive techniques.

The abrasive techniques and resulting debris often cause contamination of an adhesive, generally applied to the sheeting on-site during an application process. Furthermore, the fibrous debris generally causes a finished cellulose sheet laminate to appear deformed, whereas bumps or indentations appear on the surface of the laminate. Similarly, abrading the outer surface of a cellulose sheet may cause wrinkling or cracking of the sheet.

Thus, there is a need for method for non-abrasive mechanical relief of a cellulose sheet and an apparatus therefor.

### SUMMARY

Embodiments of the present invention generally relate a method and apparatus of non-abrasive mechanical relief of a cellulose sheet to allow for uniform radius bending. In one embodiment of the present invention, a mechanically relieved sheet comprises a sheet comprising a cellulosic material having a first surface, and at least a notched section on the first surface of the sheet comprising a plurality of indentations, wherein the first surface of the sheet is substantially free of visible cracks, wrinkles and abrasions.

In another embodiment, a method of non-abrasively relieving a cellulosic sheet comprises providing a cellulosic sheet, and scoring the cellulosic sheet in a die assembly comprising at least a first die with a plurality of substantially uniform indentations.

### BRIEF DESCRIPTION OF THE DRAWINGS

So the manner in which the above recited features of the present invention can be understood in detail, a more particular description of embodiments of the present invention, briefly summarized above, may be had by reference to embodiments, some of which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a perspective view of a mechanically relieved cellulose sheet in accordance with an embodiment of the present invention;

FIG. 2 depicts a perspective view of the mechanically relieved cellulose sheet of FIG. 1;

FIG. 3 depicts a perspective view of a mechanically relieved cellulose sheet in accordance with an embodiment of the present invention;

FIG. 4 depicts a perspective view of a male die utilized to mechanically impart relief to cellulose sheeting in accordance with an embodiment of the present invention; and

FIG. 5 depicts a flowchart of a method for mechanically relieving a cellulose sheet in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention are generally related to a method and apparatus of non-abrasive mechanical relief of a cellulose sheet. More specifically, embodiments of the present invention generally relate a method and apparatus of non-abrasive mechanical relief of a cellulose sheet to allow for substantially uniform radius bending.

FIG. 1 depicts a perspective view of a mechanically relieved cellulose sheet 100 in accordance with an embodiment of the present invention. The cellulose sheet 100 may comprise any cellulosic material suitable for embodiments of the present invention. In one embodiment, the cellulose sheet comprises recycled, corrugated container material. Other embodiments provide a cellulose sheet 100 comprising at least one of fiberboard, paper, wood-pulp product, or the like. In certain embodiments, a polymer having substantially cellulosic characteristics may be utilized as well.

The mechanically relieved cellulose sheet 100 comprises a plurality of notched or scored sections 110 on a first surface 102 of the sheet 100. In some embodiments, the notched sections 110 comprise parallel, substantially linear notches. In one embodiment, the notched sections 110 run in a machine direction. Alternative embodiments of the present invention comprise any directionality or shape of the notched sections 110.

In one embodiment, the notched sections 110 are created in parallel across the first surface 102 of the cellulose sheet 100. The notched sections 110 may be provided at any suitable spacing in accordance with embodiments of the present invention. In one embodiment, the notched sections 110 are spaced apart in a range of about 0.001 inch to about 6 inches. In another embodiment, the notched sections 110 are spaced apart in a range of about 0.01 inch to about 2 inch. In yet another embodiment, the notched sections 110 are spaced apart in a range of about 0.1 inch to about 0.5 inch. In several embodiments, the spacing is uniform across an entire surface 102, or at least a portion of a surface 102 of a cellulose sheet 100. Alternatively, however, the spacing may be variable across the entire surface 102 of a cellulose sheet 100, or at least in sections of the entire surface.

The notched sections 110 may be scored into the surface 102 of the cellulose sheet 100 to any depth suitable for embodiments of the present invention. In one embodiment, the notched sections 110 are about 0.0001 to about 1 inch deep. In another embodiment, the notched sections 110 are about 0.001 to about 0.1 inch deep. In some embodiments, the depth of the notched sections 110 is uniform across the entire surface, or at least a portion of the surface, of a cellulose sheet 100. In other embodiments, the depth of the notched sections 110 varies across the entire surface of a cellulose sheet 100, or at least portions thereof.

The width of the notched sections 110 may be any width suitable for embodiments of the present invention. In some embodiments, the width of a notched section 110 ranges from about 0.001 inch to about 1 inch. In other embodiments, the width of a notched section 110 ranges from about 0.01 inch to about 0.1 inch. Embodiments of the present embodiments provide the width of the notched sections 110 may be either uniform or variable across an entire surface, or at least part of an entire surface 102, of a cellulose sheet. In other embodiments, the width of the scored sections is variable across an entire cellulose sheet.

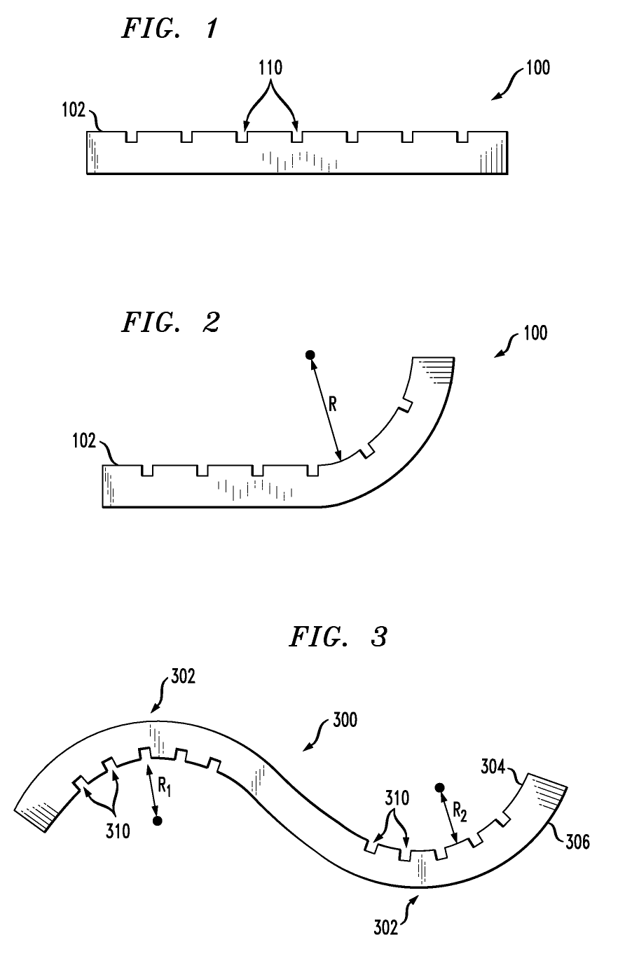

FIG. 2 depicts a perspective view of the mechanically relieved cellulose sheet 100 of FIG. 1. As shown in FIG. 2, the mechanically relieved cellulose sheet 100 is capable of being formed into a curved shape without substantial or visible cracking or wrinkling of the material surface 102. In some embodiments of the present invention, the radius R to which the cellulose sheet 100 may be formed is dependent upon the thickness of the cellulose sheet 100. In other embodiments, the radius R to which the cellulose sheet 100 may be formed is dependent upon the depth and spacing of the notched sections 110. In some embodiments, the radius R to which the cellulose sheet 100 may be formed is dependent upon the width of the notched sections 110.

In many embodiments, the radius to which the cellulose sheet 100 may be formed is dependent upon at least one of a plurality of the thickness of the cellulose sheet 100, the material properties of the composition of the cellulose sheet 100, the depth and spacing of the notched sections 110, the width of the notched sections 110, and the like.

In some embodiments, the radius R to which the cellulose sheet 100 may be formed as tight as about 0.0001 inch. In such an embodiment, the cellulose sheet 100 is capable of being formed to a tight uniform radius without visible cracking or wrinkling on the material surface 102. Embodiments of the present invention may provide any number of radii or bends in the cellulose sheet in any given application. Thus, it is understood by those of ordinary skill in the art, that a cellulose sheet, in accordance with embodiments of the present invention, may be formed to any suitable radius or suitable variable radii such that a desired formation is created.

For example, FIG. 3 depicts a perspective view of a mechanically relieved cellulose sheet 300 in accordance with an embodiment of the present invention, having at least a plurality of curved sections 302 or compound radii R1, R2 within a single cellulose sheet 100. In many embodiments, the cellulose sheet 300 comprises a plurality of notched sections 310, which may be on either a first surface 304 or second surface 306. In one embodiment, the notched sections 310 are positioned on an interior of a curved section 302, to facilitate the bending of the cellulose sheet 300.

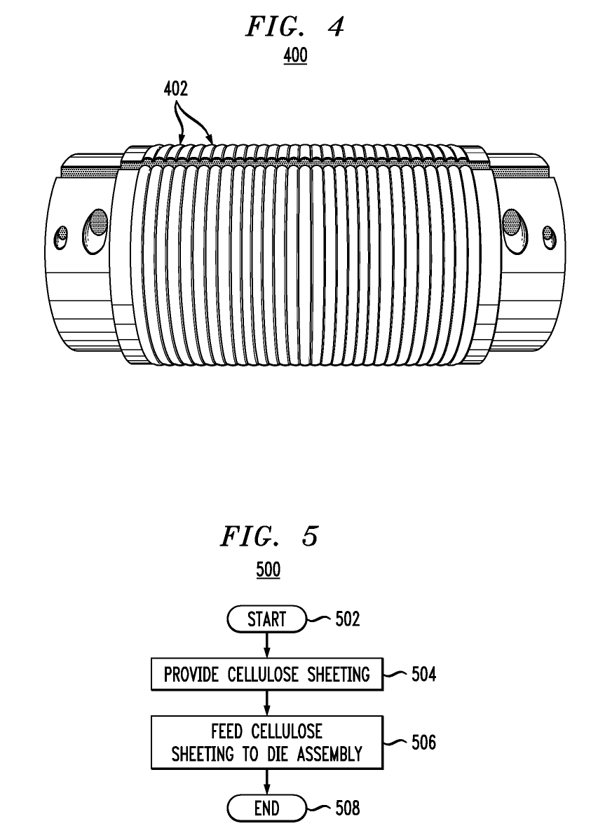

FIG. 4 depicts a perspective view of a male die utilized to mechanically impart relief to cellulose sheeting in accordance with an embodiment of the present invention. Generally, a male die 400 having a plurality grooves 402 or indentations is provided in a machine assembly. In many embodiments, the male die 400 is provided in combination with a smooth anvil die (not shown). In other embodiments, the male die 400 is mated with a female die having an inverse pattern on its surface. In one embodiment, the male die 400 is provided with an arrangement of grooves to create the pattern of notched sections 102 on a surface of a cellulose sheet 100, as described in detail above.

Generally, the male die 400, or overall die assembly, is provided with a pneumatic or hydraulic pressure system. The pressure system allows for a uniform pressure and force to be applied over the cellulose sheet 100 during manufacturing. As such, in many embodiments, a cellulosic sheet 100 processed by the male die results in uniform notched sections 102. It is contemplated by embodiments of the present invention to incorporate any suitable combination of die assembly, pressure system, die pattern, and cellulose sheet material.

FIG. 5 depicts a flowchart of a method 500 for mechanically relieving a cellulose sheet in accordance with an embodiment of the present invention. The method 500 begins at step 502, and in one embodiment, at step 504, a cellulose sheet 100 is provided. The cellulose sheet 100 may be a continuous moving web, or individual sheet. At step 506, the cellulose sheet 100 is fed into a die assembly having at least a male die 400 with a particular groove pattern in accordance with embodiments discussed herein. As the cellulose sheet 100 is fed in the die assembly, the plurality of notched sections 110 are scored into at least a surface 102 of the cellulose sheet 100. At step 508, the method 500 ends, and the resulting cellulose sheet 100 is mechanically relieved, as described herein.

Other alternative embodiments of the present invention provide that no debris remains on the cellulose sheet 100 upon removal from the die assembly. As such, additional processing of the cellulose sheet 100, for example, forming an adhesive layer over the surface of the cellulose sheet 100, may be performed. Such embodiments may laminate or extrude a layer of adhesive on the cellulose sheet 100. Furthermore, additional embodiments provide additional steps such as deforming or providing curvature to the cellulosic sheet 100, or the like.

While the foregoing is directed to embodiments of the present invention, other and further embodiments of the invention may be devised without departing from the basic scope thereof. It is understood that various embodiments described herein may be utilized in combination with any other embodiment described, without departing from the scope contained herein.

What is claimed is:

1. A mechanically relieved sheet comprising:
a sheet comprising a cellulosic material having a first surface;
at least a notched section on the first surface of the sheet comprising a plurality of indentations;
wherein the first surface of the sheet is substantially free of visible cracks, wrinkles and abrasions.

2. The mechanically relieved sheet of claim 1, wherein at least a portion of the sheet is curved in accordance with a predetermined radius.

3. The mechanically relieved sheet of claim 1, wherein the plurality of indentations are spaced apart at between about 0.001 inches and about 6 inches.

4. The mechanically relieved sheet of claim 3, wherein the plurality of indentations are spaced apart at between about 0.01 inches and about 2 inches.

5. The mechanically relieved sheet of claim 4, wherein the plurality of indentations are spaced apart at between about 0.1 inches and about 0.5 inches.

6. The mechanically relieved sheet of claim 1, wherein the plurality of indentations are formed in parallel across the first surface of the sheet.

7. The mechanically relieved sheet of claim 1, wherein the plurality of indentations comprise substantially linear notches.

8. The mechanically relieved sheet of claim 1, wherein the depth of the plurality of indentations is between about 0.0001 inches and about 1 inch.

9. The mechanically relieved sheet of claim 8, wherein the depth of the plurality of scored sections is between about 0.001 inches to about 0.1 inches.

10. The mechanically relieved sheet of claim 1, wherein the width between the plurality of indentations is between about 0.001 inches and about 1 inch.

11. The mechanically relieved sheet of claim 10, wherein the width between the plurality of indentations is between about 0.01 inches and about 0.1 inches.

12. The mechanically relieved sheet of claim, further comprising a layer of adhesive disposed on the cellulose sheet.

13. A mechanically relieved sheet comprising:
a sheet comprising a cellulosic material having a first surface;
at least a notched section on the first surface of the sheet comprising a plurality of indentations; and
a layer of adhesive disposed on the cellulose sheet;
wherein at least a portion of the sheet is curved in accordance with a predetermined radius.

14. The mechanically relieved sheet of claim 13, wherein the first surface of the sheet is substantially free of visible cracks, wrinkles and abrasions.

15. A method of non-abrasively relieving a cellulosic sheet comprising:
providing a cellulosic sheet; and
scoring the cellulosic sheet in a die assembly comprising at least a first die with a plurality of substantially uniform indentations.

16. The method of claim 15, wherein the die assembly applies a uniform pressure and force over the sheet material.

17. The method of claim 15, further comprising the step of:
applying an adhesive layer to the mechanically relieved surface of the sheet material.

18. The method of claim 15, wherein upon removal from the die assembly, the cellulosic sheet is substantially debris-free.

19. The method of claim 18, wherein the cellulosic sheet remains substantially free of visible cracks, wrinkles, and abrasions.

20. The method of claim 15, further comprising:
forming at least a curved section of the sheet in accordance with a predetermined radius.
